(19) United States
(12) Patent Application Publication
(10) Pub. No.: US 2007/0011132 A1
(43) Pub. Date: Jan. 11, 2007

(54) Named entity translation

(75) Inventors: Ming Zhou, Beijing (CN); Long Jiang, Beijing (CN)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/155,829

(22) Filed: Jun. 17, 2005

(51) Int. Cl. G06F 17/30

(52) U.S. Cl. 707/1

(57) ABSTRACT

Named entity translation of a named entity in a source language is translated to a target language by combining a transliteration of the named entity with data mining in the target language.

### BACKGROUND

The discussion below is merely provided for general background information and is not intended to be used as an aid in determining the scope of the claimed subject matter.

Translation of proper names is generally recognized as a significant problem in many multi-lingual text and speech processing applications. A large quantity of new named entities appear every day in newspapers, web sites and technical literatures, but their translations normally cannot be found in the translation dictionaries. Improving the named entity translation is very important to translation systems and cross language information retrieval applications. Moreover, it also benefits the bilingual resources acquisition from the web and translation knowledge acquisition from the corpora.

Commonly, when foreign names are used in a different language, the pronunciation of the name is modified. In other words, when a speaker reads a foreign name in his own language, the name is recast according to the sounds of that language so that it sounds different from the name pronounced in the original language. The name may then be rendered into the script in which the speaker's language is written. This process is referred to as transliteration.

Since a large proportion of named entities can be translated by transliteration (for example, English to Chinese), some have tried to build transliteration models with a rule-based approach or a statistics-based approach. However, neither approach is without problems. The rule-based approach adopts linguistic rules for the deterministic generation of translation. However, it is often difficult to systematically select, the best translation from the multiple Chinese characters with same pronunciation.

The statistics-based transliteration approaches select the most probable translations based on the knowledge learned from the training data. This approach, however, still cannot work perfectly when there are multiple standards. For example, “ford” at the end of an English named entity is transliterated into [symbol] in most cases (e.g., “Blanford”-> [symbol] ), but some times, it is transliterated into [symbol] (e.g., “Stanford”-> [symbol] ). As this example indicates, many mistakes of transliteration come from the distortion of the standards from the transliteration.

In recent years, the Internet or web has been used to extract the translation of named entities. In one approach, web pages of a target language (e.g. Chinese) are searched using the terms or named entities of the source language (e.g. English). Translation candidates are extracted based on SCPCD scores with ranking of generated candidates performed with Chi-Square and context vectors. Although limited success has been achieved for some high frequency terms and some named entities, the computational cost of the approach is very high and it cannot handle the cases where the translations do not or scarcely appear in the searched data.

### SUMMARY

This Summary is provided to introduce some concepts in a simplified form that are further described below in the Detailed Description. This Summary is not intended to identify key features or essential features of the claimed subject matter, nor is it intended to be used as an aid in determining the scope of the claimed subject matter.

Named entity translation of a named entity in a source language is translated to a target language by combining a transliteration of the named entity with data mining in the target language. Translation candidates can be obtained by forming search queries to be used by a search system or engine operable with the database. In a first instance, the search queries can include at least one character of the transliteration of the named entity in combination with the named entity in the source language. Translation candidates are obtained from the search results.

In a second instance, a search query can include just the named entity in the source language. The search results are then processed to obtain further translation candidates, exemplary processing can include co-occurrence processing and/or transliteration likelihood. The first-mentioned translation candidates and the further translation candidates can then be processed to obtain a final translation for the named entity.

### BRIEF DESCRIPTION OF THE DRAWINGS

FIG. 1 is a block diagram of one embodiment of an environment in which aspects of the present invention can be used.

FIGS. 2A and 2B taken together provide a flow chart illustrating a method for translating named entities.

FIG. 3 is a block diagram illustrating modules and data for performing the method of FIGS. 2A and 2B.

### DETAILED DESCRIPTION

One aspect herein described relates to named entity translation. However, prior to discussing this and other aspects in greater detail, one illustrative environment in which the present invention can be used will be discussed.

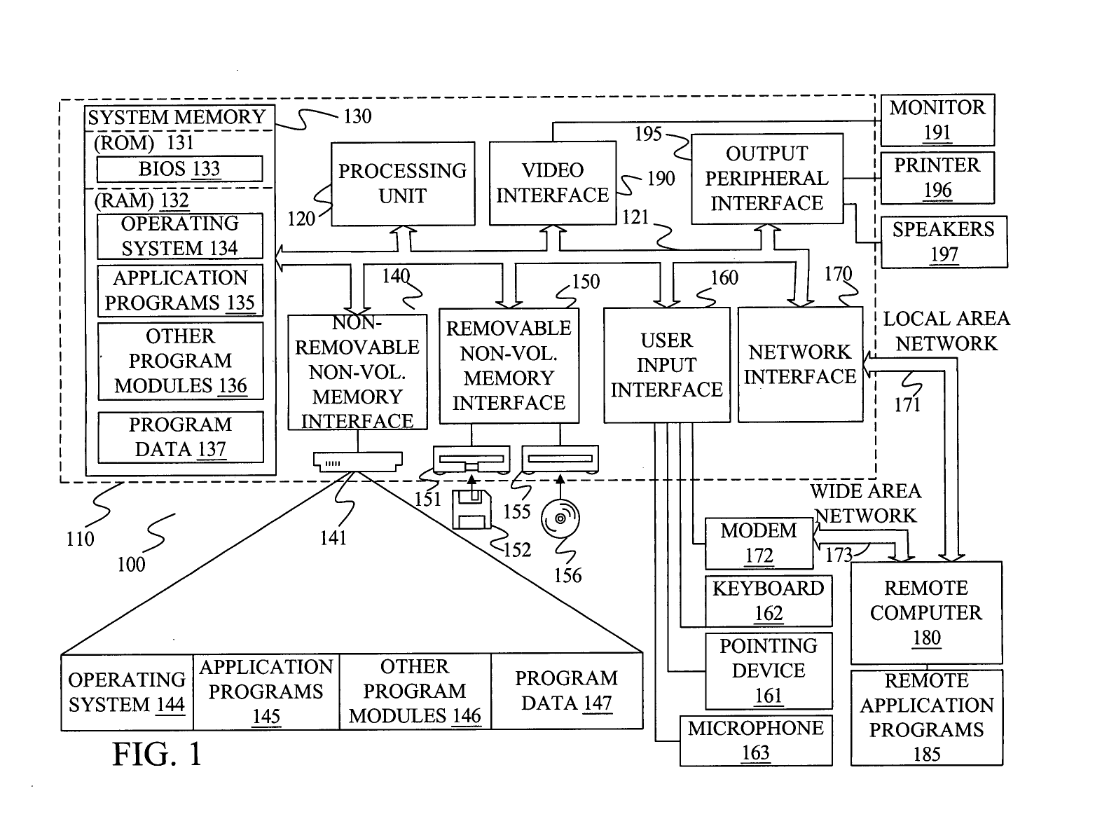

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. Those skilled in the art can implement the description and/or figures herein as computer-executable instructions, which can be embodied on any form of computer readable media discussed below.

The invention may also be practiced in distributed computing environments where tasks are performed by remote processing devices that are linked through a communications network. In a distributed computing environment, program modules may be located in both locale and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a locale bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way o example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a locale area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present invention can be carried out on a computer system such as that described with respect to FIG. 1. However, the present invention can be carried out on a server, a computer devoted to message handling, or on a distributed system in which different portions of the present invention are carried out on different parts of the distributed computing system.

As indicated above, one aspect includes named entity translation. By way of example, the following description will be provided in the context of English (source language) to Chinese (target language) translation. Nevertheless, it should be understood neither the scope of the claims nor the application of the invention is limited to this context, but rather aspects of the invention can be applied to translation using other languages.

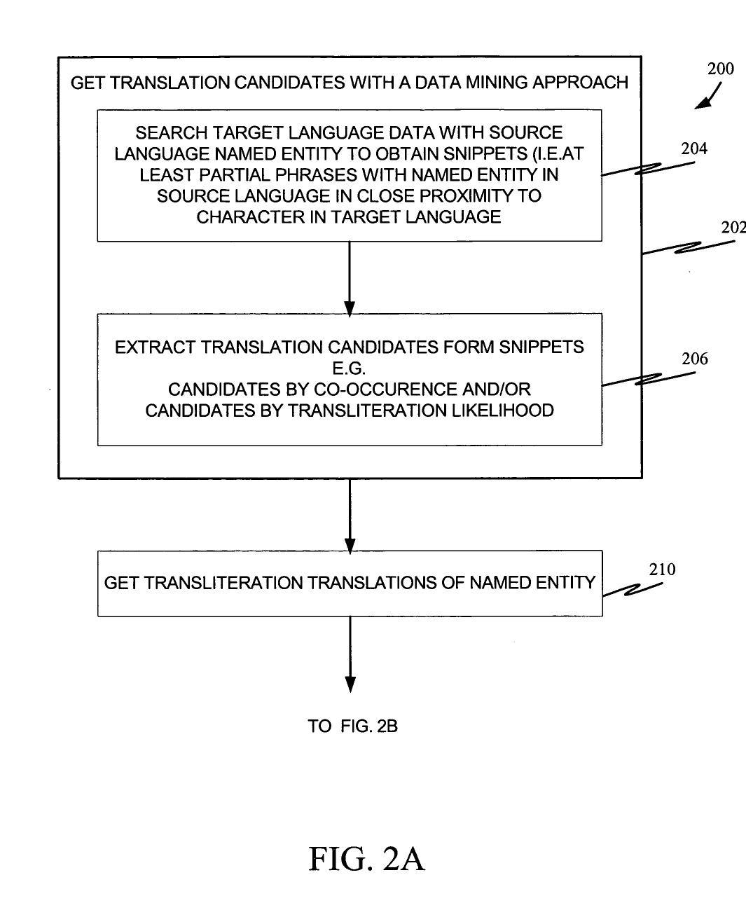

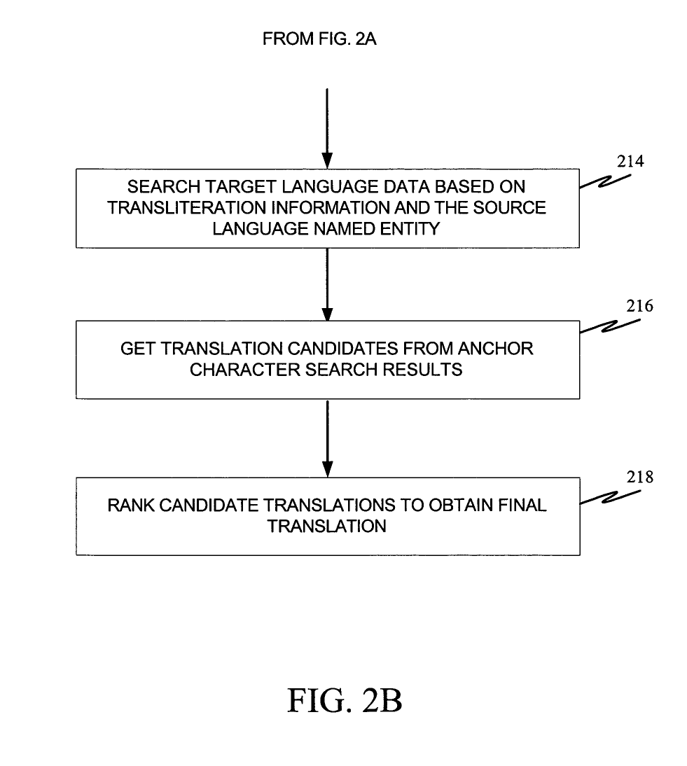

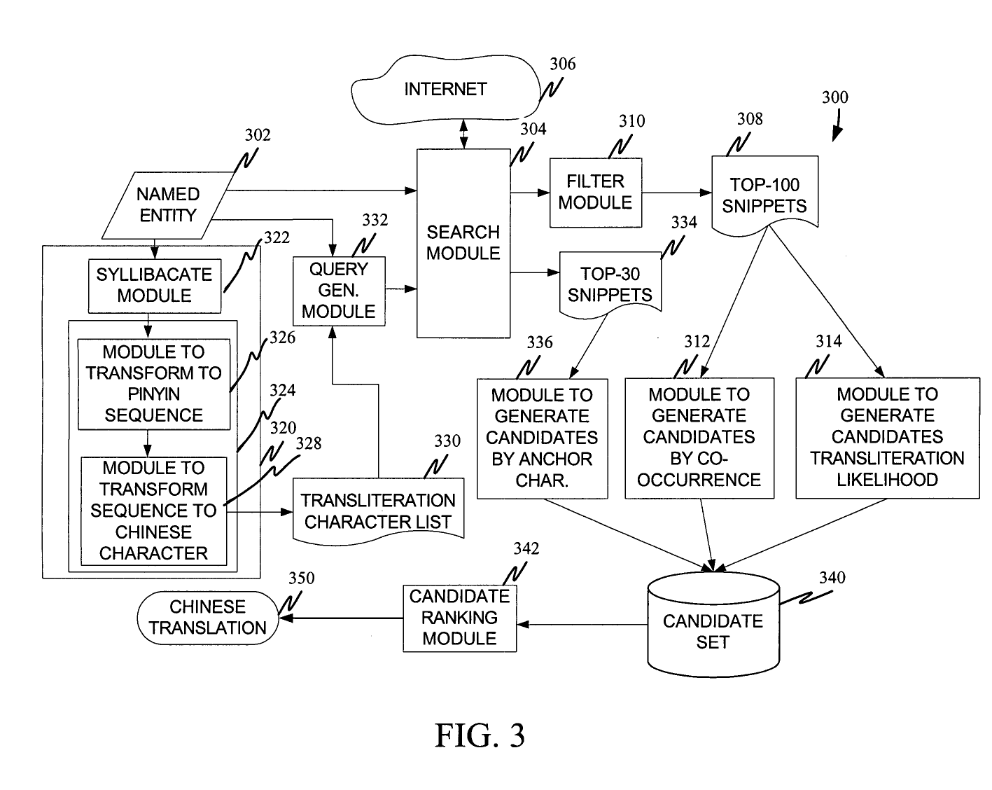

FIGS. 2A and 2B generally illustrates a method at 200 for performing named entity translation, while system 300 schematically illustrated in FIG. 3 provides components or modules for performing method 200. The modules and corpus storage devices illustrated in FIG. 3 can be embodied using the environment described above without limitation.

As appreciated by those skilled in the art, the order of steps illustrated in FIGS. 2A and 2B and described below may be changed without affecting the concepts contained therein. Generally, at step 202, translation candidates are obtained with a data mining approach. Commonly, data mining can be performed using the Internet or the World Wide Web (“web”); however it should be understood that other databases can be used if desired. In FIG. 3, the named entity to be translated is indicated at 302. At step 204, the named entity 302 is received by a search module 304, which in turn accesses the database (herein, Internet 306) to obtain a selected number of snippets or partial phrases indicated at 308. In one embodiment, the search module 304 can take the form of general search systems such as but not limited to Yahoo, Google and MSN Search, where the named entity 302 is provided in the form of a query to the search system and the search module 304 provides a list of links for various websites having the search term (i.e. named entity) therein as indicated commonly by a portion of the website being displayed proximate the website link. In other words, the named entity in the source language is in close proximity (i.e. in a close enough position so that it is possible that a translation of the named entity exists). Commonly, the possible translation (which can comprise one or more characters) is adjacent the named entity; however, this may vary depending on the source and/or target language. Each portion of the website returned by the search system comprises a snippet or partial phase.

It should be noted that the data (e.g. web pages) searched by the search module 304 are those of the target language in view that the results 308 would include the named entity in the source language and words/characters of the target language. To this end, it may be desirable to provide filtering so as to compile a list of snippets or results having these characteristics. Filtering module 310 can provide such filtering. In one embodiment, a simple method of checking the Unicode value of each character in each snippet is used. If there is no character in a snippet whose Unicode value is within the range of the target language, the snippet is discarded. After filtering out the non-target language pages, the top-N snippets 308 are selected.

From snippets 308, translation candidates are extracted at step 206. Two exemplary methods are provided herein obtaining the candidates by co-occurrence and for obtaining the candidates by using transliteration characters. Referring first to co-occurrence candidate generating module 312, a simplified approach of the method described in “Translating unknown cross-lingual queries in digital libraries using a web-based approach”, by Jenq-Haur Wang, Jei-Wen Teng, Pu-Jen Cheng, Wen-Hsiang Lu, Lee-Feng Chien, published in JCDL 2004: 108-116 is used. In particular, the following steps are performed:
1. Use Mutual Information (MI) to measure the association between the input named entity E and each target character, denoted as cᵢ, that appears in the snippets 308

$$M I = p ( c i , E ) log \frac{p ( c i , E )}{p ( c i ) p ( E )}$$

where, p(cᵢ) is the probability of cᵢ appearing in web pages and p(E) is the probability of E appearing in web pages. p(cᵢ, E) is the probability of E and cᵢ, appearing in the same web pages. p(cᵢ), p(E) and p(cᵢ, E) can be calculated approximately using search engine, (e.g., p(cᵢ) equals the percentage of the web pages containing cᵢ in all web pages), and p(cᵢ) can be obtained as prior probabilities.
2. Rank all characters based on their MI value and select the top characters (e.g. 5) as anchors.
3. Extract all N-gram strings from phrases containing the selected anchors mentioned above. One can select the words (or terms) from these N-gram strings by the method described in (Wang et al., 2004) that uses SCPCD and frequency scores.

$$SCPCD ( w 1 … w n ) = \frac{LC ( w 1 … w n ) RC ( w 1 … w n )}{\frac{1}{n - 1} {\sum }_{i = 1}^{n - 1} freq ( w 1 … w i ) freq ( w i + 1 … w n )}$$

SCPCD is a score to indicate whether a string of characters is a word. LC(w1 . . . wn) is the number of unique left adjacent characters. RC(w1 . . . wn) is the number of unique right adjacent characters. freq(wi . . . wn) is the frequency of the N-gram.
4. For each anchor, select N-gram strings (e.g. 3) with the highest value of SCPCD*freq(wi . . . wn).

Compared with (Wang et al., 2004), this approach reduces the computational complexity. In addition, the candidates can be collected which are not translated in transliteration, as described below. For example, the transliteration of “Yellowstone”:

[symbol]

is wrong. However, its correct translation candidate: can be obtained with this approach.

Transliteration candidate generating module 314 extracts candidates using a transliteration approach. Generally, this approach is based on the proportion of the target language characters that are commonly used in transliteration. The method includes:

1. Estimating the minimal length (á) and maximal length (â) of the transliteration with a simple method. á is defined as the number of those syllables containing vowels (a, e, i, o, u), and a is defined as the number of syllables; For instance, “Clinton” is split into three syllables “C”, “lin”, “ton”. á is 2 and â is 3;

2. Extracting all substrings whose length are between a and a in a fixed size window (e.g. size=±12) surrounding the named entity in all snippets 308; and

3. Selecting a string as the translation candidate if more than a predefined threshold (e.g., 50%) of its characters are transliteration used target language characters.

This approach aims to extract the candidates which are transliterated but scarcely appear in the search results. To reduce the computational cost, the lexical boundary of candidates is not decided and will be left to the ME ranking model, described below.

Referring back to FIG. 2A, transliteration translations are obtained at step 210. In FIG. 3, this step is performed by transliteration module 320. Generally, module 320 includes a module 322 to isolate the translation units of the named entity 302 (herein by way of example, comprising syllables) and a conversion module 324. For some conversions, such as English to Chinese multiple steps may be involved. As illustrated in FIG. 3, given an English named entity 302, it is first segmented into a consecutive sequence of syllables with a few linguistic rules with module 322. In one embodiment, given an English named entity 302, denoted as E, the named entity is first syllabicated into a syllable sequence PE={e1, e2 . . . en} with the following linguistic rules:

1) a, i, e, o, u are vowels. y is regarded as a vowel when it is not followed by a vowel. All other characters are consonants;

2) Duplicate the nasals m and n whenever they are surrounded by vowels. And then when they appear behind a vowel, they will be combined with that vowel to form a new vowel;

3) Consecutive consonants are separated;

4) Consecutive vowels are treated as a single vowel;

5) A consonant and a following vowel are treated as a syllable; and

6) Each isolated vowel or consonant is regarded as an individual syllable. For example, “Campanelli” is split into “cam/pan/ne/l/li”. “Clinton” is split into “C/lin/ton”. “Lasky” is split into “La/s/ky”. “Meyerson” is split into “Me/ye/rson”.

For the generated syllable sequence PE={e1, e2 . . . en}, module 326 is then used to get the corresponding Chinese Pinyin sequence PC={Pc1, Pc2 . . . Pcm} such that P(PC|PE) is maximized, i.e.,

$$\begin{matrix}P {C}^{*} = {arg max}_{PC} p ( P C \text{\vert} P E ) \\ = arg max p ( P C ) p ( P E \text{\vert} P C )\end{matrix}$$

where P(PC) is the probability of Chinese Pinyin sequence and P(PE|PC) is the translation probability of PC into PE.

Then, given the Pinyin string, PC={Pc1, Pc2 . . . Pcm} and using module 328, the next step is to get a Chinese character string C={c1, c2 . . . cm} that maximizes

$$\begin{matrix}{c}^{*} = {arg max}_{c} p ( c \text{\vert} p c ) \\ = {arg max}_{c} p ( p c \text{\vert} c ) p ( c ) \\ \approx {arg max}_{c} p ( c )\end{matrix}$$

thereby, comprising the resulting transliteration character sequence 330.

The translation model P(PE|PC) can be trained with GIZA++ 1 (http://www-i6.informatik.rwthaachen.de/Colleagues/och/software/G IZA++.html) using LDC Chinese-English Name Entity Lists Version 1.0 (Catalog Number by LDC: LDC2003E01). In GIZA++ setting, 5 iterations can be used of Model-1; 5 iterations of Model-3; 5 iterations of HMM and 5 iterations of Model-4.

The two language models for P(PC) and P(C) can be built with CMU SLM Toolkit V2.0 (http://www.speech.cs.cmu.edu/SLM_info.html) with the Chinese part of the LDC data. In the LM training process, a trigram model can be used, while Good-Turing discounting and Katz back-off for smoothing can also be used. At runtime, ISI ReWrite Decoder 1.0 (http://www.isi.edu/naturallanguage/software/decoder/index.html) is used to search the best Pinyin sequence and then Chinese character sequence, both with a fast greedy search algorithm.

Referring back to FIG. 2B, at step 214, the target language data 306 is searched using a combination of transliteration information/list 330 (from step 210) and the named entity in the source language 302. In one embodiment, this combination can comprise providing the search module 304 with queries having one (or more) of the characters (“anchor characters”) in list 330 and identified at step 210 in combination with the named entity in the source language 302.

Translating a named entity based on steps 210 and 214 comprises a separate aspect of the present invention.

Using English to Chinese and FIG. 3 by way of example, the web 306 is searched with an anchor character and the input NE. In particular, each character of list 330, ci, is combined with the English named entity 302 as a query by module 332 to search in Chinese web pages 306. A number of the top snippets 334 (e.g. 30) are selected by module 304 in a manner similar to step 206.

From the position of ci in a snippet, all the N-gram character strings that include ci are obtained at step 216 with anchor character candidate generating module 336, where N is between the estimated minimal and maximal length of the named entity translation. The extracted N-gram character strings are put into the translation candidate set 340 along with those obtained from modules 312 and 314.

It may be helpful to explain steps 210, 214 and 216 with an example. Suppose “Nikos” is transliterated at step 210 into

[symbol]

The Chinese word is then split into three characters: [symbol] , [symbol] ,

[symbol]

Each of these characters is combined with “Nikos” at step 214 to form a query to search for Chinese web pages 306.

For each query, the top 30 returned snippets are selected to form a small corpus. The estimated minimal and maximal length of the translation of “Nikos” is 2 and 3 according to the method described above. For example, in the corpus just formed, the position where

[symbol]

appears is searched in the snippets, and all bigram (minimal length) and trigram (maximal length) strings are selected as candidates.

At step 218, the candidate translations can be processed by module 342 to obtain the named entity translation. In one embodiment, as illustrated the candidate translations can be ranked by ranking module with the highest ranked candidate provided as the named entity translation 350.

In one embodiment, an ME model is used to rank the translation candidates obtained above with the following features:
1. The Chi-Square of translation candidate C and the input English named entity E, which has been described in “Translating Unknown Queries with Web Corpora for Cross-Language Information Retrieval”, by Pu-Jen Cheng, Jei-Wen Teng, Ruei-Cheng Chen, Jenq-Haur Wang, Wen-Hsiang Lu, and Lee-Feng Chien, published in SIGIR 2004: 146-153, can be represented as:

$${S}_{CS} ( C , E ) = \frac{N \times {( a \times d - b \times c )}^{2}}{( a + b ) \times ( a + c ) \times ( b + d ) \times ( c + d )}$$

where,
a=the number of pages containing both C and E
b=the number of pages containing C but not E
c=the number of pages containing E but not C
d=the number of pages containing neither C nor E
N=the total number of pages, i.e., N=a+b+c+d
Here, N can be set to 4 billion. Actually, the value of N does not affect the ranking once it is positive. C and E can be combined as a query to search with search module 304 for Chinese web pages. The resulting page contains the total page number containing both C and E which is “a” in the equation below. C and E are then used as queries respectively to search the web. The page number Nc and Ne can then be obtained. So b=Nc−a and c=Ne−a and d=N−a−b−c.
2. Contextual feature Scf1(C,E)=1 if in any of the snippets selected, E is in a bracket and follows C or C is in a bracket and follows E;
3. Contextual feature Scf2(C,E)=1 if in any of the snippets selected, E is second to C or C is second to E;
4. Similarity of C and E in terms of transliteration score (TL).

$$T L ( C , E ) = \frac{L ( P e ) - E D ( P e , P Y c )}{L ( P e )}$$

Pe is the transliterated Pinyin sequence of E and PYc is the Pinyin sequence of C. L (Pe) is the length of Pe, and ED(Pe,PYc) is the edit distance between Pe and PYc.

With these features, the ME model is expressed as:

$$P ( C \text{\vert} E ) = {p}_{{λ}_{1}^{M}} ( C \text{\vert} E ) = \frac{exp [ {\sum }_{m = 1}^{M} {λ}_{m} {h}_{m} ( C , E ) ]}{{\sum }_{C} exp [ {\sum }_{m = 1}^{M} {λ}_{m} {h}_{m} ( C , E ) ]}$$

where, C denotes Chinese candidate, E denotes English named entity, and m is the number of features.

Although the present invention has been described with reference to particular embodiments, workers skilled in the art will recognize that changes may be made in form and detail without departing from the spirit and scope of the invention.

What is claimed is:

1. A computer-implemented method of translating a named entity from a source language to a target language, comprising:
obtaining translation candidates for the named entity based on using data mining of a database comprising the target language;
obtaining a transliteration translation in the target language of the named entity; and
translating the named entity based on the translation candidates and the transliteration translation.

2. The computer-implemented method of claim 1 wherein obtaining translation candidates for the named entity comprises searching the database to obtain at least partial phrases having the named entity in the source language in close proximity to at least one character in the target language.

3. The computer-implemented method of claim 2 wherein obtaining translation candidates for the named entity comprises obtaining translation candidates from the partial phrases using co-occurence.

4. The computer-implemented method of claim 2 wherein obtaining translation candidates for the named entity comprises obtaining translation candidates from the partial phrases using transliteration likelihood.

5. The computer-implemented method of claim 4 wherein obtaining translation candidates for the named entity comprises obtaining translation candidates from the partial phrases using transliteration likelihood.

6. The computer-implemented method of claim 1 wherein translating the named entity based on the translation candidates and the transliteration translation comprises using the transliteration translation in combination with the named entity in the source language to obtain further translation candidates for the named entity using data mining of a database.

7. The computer-implemented method of claim 6 wherein using the transliteration translation in combination with the named entity in the source language comprises forming a query for searching the database.

8. The computer-implemented method of claim 7 wherein forming a query for searching the database comprises using at least one character of the transliteration translation in combination with the named entity in the source language.

9. The computer-implemented method of claim 8 wherein forming a query for searching the database comprises forming successive queries using different characters of the transliteration translation in combination with the named entity in the source language in each query.

10. The computer-implemented method of claim 6 wherein translating the named entity based on the translation candidates and the transliteration translation comprises ranking the first-mentioned translation candidates and the further translation candidates.

11. The computer-implemented method of claim 10 wherein ranking the first-mentioned translation candidates and the further translation candidates comprises using ranking based on maximum entropy.

12. A computer-readable medium having instructions for translating a named entity from a source language to a target language, the instructions comprising:
a transliteration module for obtaining a transliteration translation in the target language of a named entity in the source language;
a query generating module adapted to combine at least one character of the transliteration translation with the named entity in the source language to form at least one query;
a search module adapted to receive the at least one query, search a database of the target language and provide translation candidates in accordance with the at least one query; and
a processing module adapted to process the translation candidates to obtain the translation of the named entity.

13. The computer-readable medium of claim 12 wherein the query generating module is adapted to combine different characters of the transliteration translation with the named entity in the source language to form a plurality of queries, and wherein the search module is adapted to receive each of the queries and obtain search results in accordance with each query.

14. The computer-readable medium of claim 13 wherein a processing module comprises a ranking module adapted to rank the translation candidates.

15. The computer-readable medium of claim 14 wherein the search module is adapted to receive a query having just the named entity in the source language and generate partial phrases having further translation candidates in the target language and the named entity in the source language.

16. The computer-readable medium of claim 15 and further comprising a module adapted to generate a second set of translation candidates from the partial phrases based on co-occurrence, and wherein the processing module is adapted to process the first-mentioned translation candidates and the second set translation candidates to obtain the translation of the named entity.

17. The computer-readable medium of claim 16 and further comprising a module adapted to generate a third set of translation candidates from the partial phrases based on transliteration likelihood, and wherein the processing module is adapted to process the first-mentioned translation candidates, the second set of translation candidates and the third set of translation candidates to obtain the translation of the named entity.

18. The computer-readable medium of claim 15 and further comprising a module adapted to generate a second set of translation candidates from the partial phrases based on transliteration likelihood, and wherein the processing module is adapted to process the first-mentioned translation candidates and the second set translation candidates to obtain the translation of the named entity.

19. A computer-readable medium having instructions for translating a named entity from a source language to a target language, the instructions comprising:
obtaining a transliteration translation in the target language of a named entity in the source language;
combining at least one character of the transliteration translation with the named entity in the source language to form at least one query;
searching a database of the target language to obtain a first set of translation candidates in accordance with the at least one query;
searching the database of the target language to obtain a second set of translation candidates based on results having at least partial phrases having the named entity in the source language in close proximity to at least one character in the target language; and
processing the first and second sets translation candidates to obtain the translation of the named entity.

20. The computer-readable medium of claim 1 wherein searching the database of the target language to obtain the second set of translation candidates based on the results having at least partial phrases having the named entity in the source language in close proximity to at least one character in the target language comprises at least one of:
obtaining the second set of translation candidates from the partial phrases using co-occurrence; and
obtaining the second set of translation candidates from the partial phrases using transliteration likelihood.
